(19) United States
(12) Patent Application Publication
(10) Pub. No.: US 2017/0130589 A1
(43) Pub. Date: May 11, 2017

(54) ARTICLE, COMPONENT, AND METHOD OF COOLING A COMPONENT

(71) Applicant: GENERAL ELECTRIC COMPANY, Schenectady, NY (US)

(72) Inventors: Yan CUI, Greer, SC (US); Gary Michael ITZEL, Simpsonville, SC (US); Srikanth Chandrudu KOTTILINGAM, Greenville, SC (US); Dechao LIN, Greer, SC (US)

(21) Appl. No.: 14/933,193

(22) Filed: Nov. 5, 2015

(51) Int. Cl. F01D 5/18; F01D 25/12; F01D 9/02

(52) U.S. Cl. CPC F01D 5/18; F01D 9/02; F01D 25/12; F05D 2220/30; F05D 2260/201

(57) ABSTRACT

An article and a component are provided. The article includes a base portion arranged and disposed to be positioned within a component, and an arrangement of apertures formed in the base portion, each of the apertures extending through the base portion. The arrangement of apertures is arranged and disposed to provide shadowless cooling of an inner surface of the component. The component includes a body portion having an inner surface and an outer surface, the inner surface defining an inner region, and an article positioned within the inner region, the article comprising a base portion and an arrangement of apertures formed in the base portion, each of the apertures extending through the base portion. The arrangement of apertures is arranged and disposed to provide shadowless cooling of the inner surface of the body portion. Also provided is a method of cooling a component including an article positioned therein.

### FIELD OF THE INVENTION

The present invention is directed to an article, a component, and a method of cooling a component. More particularly, the present invention is directed to a cooling article, a component including the cooling article, and a method of cooling the component including the cooling article.

### BACKGROUND OF THE INVENTION

Turbine systems are continuously being modified to increase efficiency and decrease cost. One method for increasing the efficiency of a turbine system includes increasing the operating temperature of the turbine system. To increase the temperature, the turbine system must be constructed of materials which can withstand such temperatures during continued use.

In addition to modifying component materials and coatings, one common method of increasing temperature capability of a turbine component includes the use of impingement cooling. Impingement cooling generally includes directing a cooling fluid through one or more apertures within an inner region of an article, the cooling fluid contacting (i.e., impinging upon) an inner surface of the article, which in turn cools the article. The apertures are normally formed in an insert, such as an impingement sleeve, on which they are distributed in parallel rows or columns.

Typically, each of the apertures in the insert directs a single fluid stream towards an inner surface of the article being cooled. This single fluid stream is usually concentrated so that the fluid exiting the aperture is able to reach the inner surface with sufficient velocity for the impingement cooling. However, the concentrated fluid stream also focuses the cooling of the article to the point of contact between the fluid stream and the inner surface. As such, to cool the entire article, a plurality of closely spaced apertures are formed in the insert. While these apertures may be concentrated in areas of high heat load, a temperature gradient is still formed in the article between points of fluid contact.

### BRIEF DESCRIPTION OF THE INVENTION

In an embodiment, an article includes a base portion arranged and disposed to be positioned within a component, and an arrangement of apertures formed in the base portion, each of the apertures extending through the base portion. The arrangement of apertures is arranged and disposed to provide shadowless cooling of an inner surface of the component.

In another embodiment, a component includes a body portion having an inner surface and an outer surface, the inner surface defining an inner region, and an article positioned within the inner region, the article comprising a base portion and an arrangement of apertures formed in the base portion, each of the apertures extending through the base portion. The arrangement of apertures is arranged and disposed to provide shadowless cooling of the inner surface of the body portion.

In another embodiment, a method of cooling a component includes directing a fluid into an article within an inner region of the component, the inner region being defined by an inner surface of a body portion of the component, generating a fluid flow through an arrangement of apertures formed in a base portion of the article, each of the apertures extending through the base portion, and contacting the inner surface of the body portion with the fluid flow, the contacting of the inner surface providing shadowless cooling of the inner surface.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a front perspective view of a component, according to an embodiment of the disclosure.

FIG. 2 is a section view of the component of FIG. 1, taken along the line 2-2, according to an embodiment of the disclosure.

FIG. 3 is a front perspective view of the article of FIG. 2, according to an embodiment of the disclosure.

FIG. 4 is a section view of the component of FIG. 1, taken along the line 2-2, according to an alternate embodiment of the disclosure.

FIG. 5 is a front perspective view of the article of FIG. 4, according to an embodiment of the disclosure.

FIG. 6 shows an arrangement of apertures, according to an embodiment of the disclosure.

FIG. 7 shows an arrangement of apertures, according to an alternate embodiment of the disclosure.

FIG. 8 shows an arrangement of apertures, according to an alternate embodiment of the disclosure.

FIG. 9 shows an arrangement of apertures, according to an alternate embodiment of the disclosure.

FIG. 10 shows an arrangement of apertures, according to an alternate embodiment of the disclosure.

FIG. 11 is a perspective view of an arrangement of apertures joined to an article, according to an embodiment of the disclosure.

Wherever possible, the same reference numbers will be used throughout the drawings to represent the same parts.

### DETAILED DESCRIPTION OF THE INVENTION

Provided are an article, a component, and method of cooling a component. Embodiments of the present disclosure, for example, in comparison to concepts failing to include one or more of the features disclosed herein, decrease or eliminate localized overheating of components, decrease formation of temperature gradients within components, increase uniformity of cooling, more evenly distributes cooling fluid, increase creep resistance, increase oxidation resistance, increase component life, facilitate use of increased system temperatures, increase system efficiency, or a combination thereof.

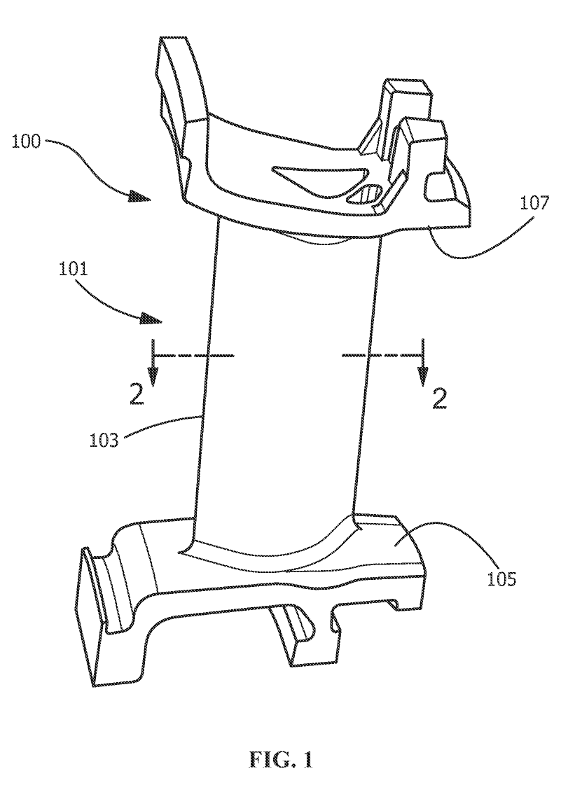

Referring to FIG. 1, in one embodiment, a component 100 includes, but is not limited to, a turbine nozzle 101. The turbine nozzle 101 has an airfoil portion 103 positioned between a first end wall 105 and a second end wall 107. The airfoil portion 103 is configured to direct airflow within a turbine system. Additionally, the airfoil portion 103 is configured to receive a fluid from the turbine system and direct the fluid to provide cooling of the nozzle 101. Although described herein with regard to a turbine nozzle, as will be appreciated by those skilled in the art, the component 100 is not so limited and may include any other component suitable for receiving a cooling fluid, such as, for example, a hollow component, a hot gas path component, a shroud, a bucket, a vane, or a combination thereof.

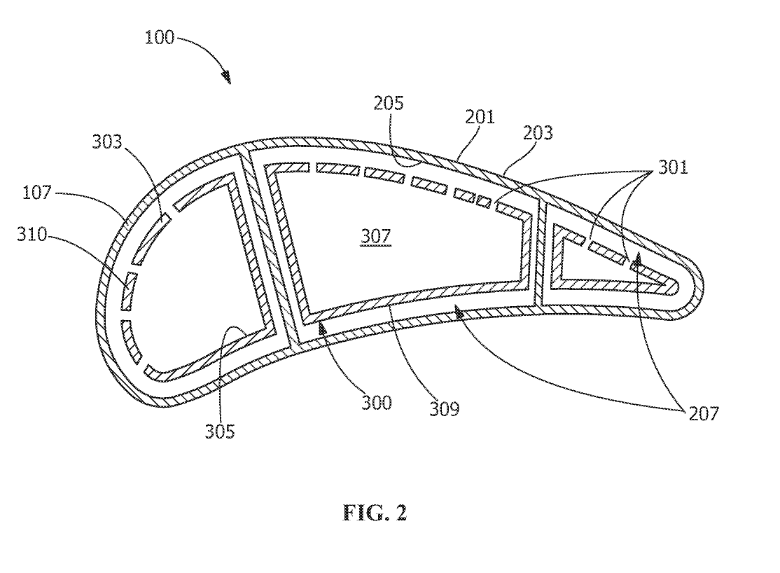

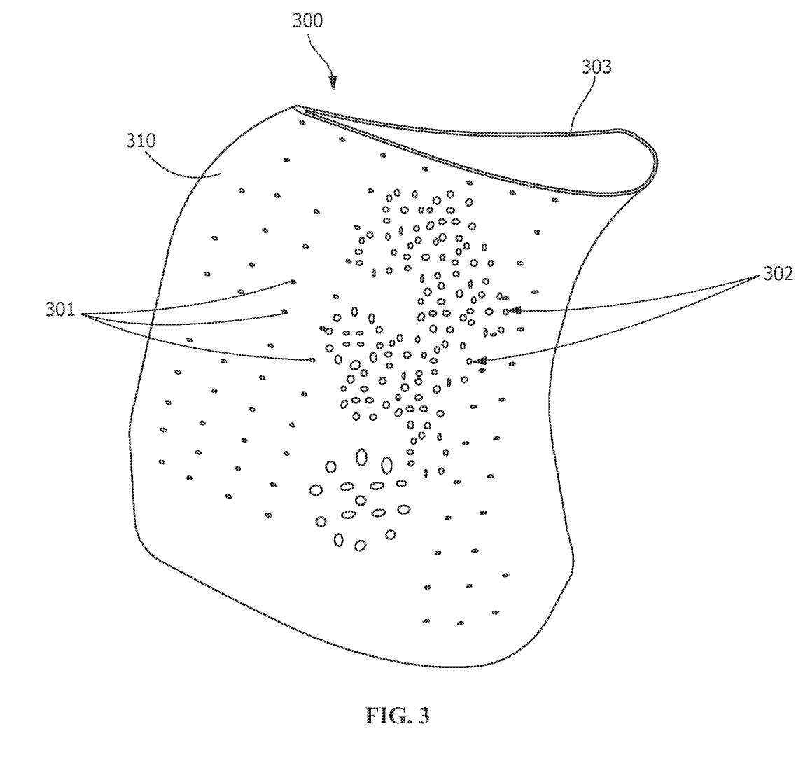

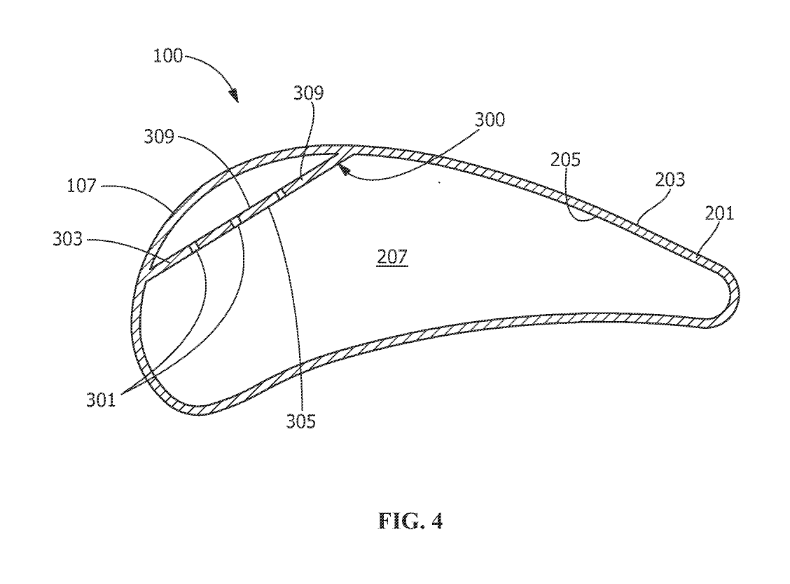

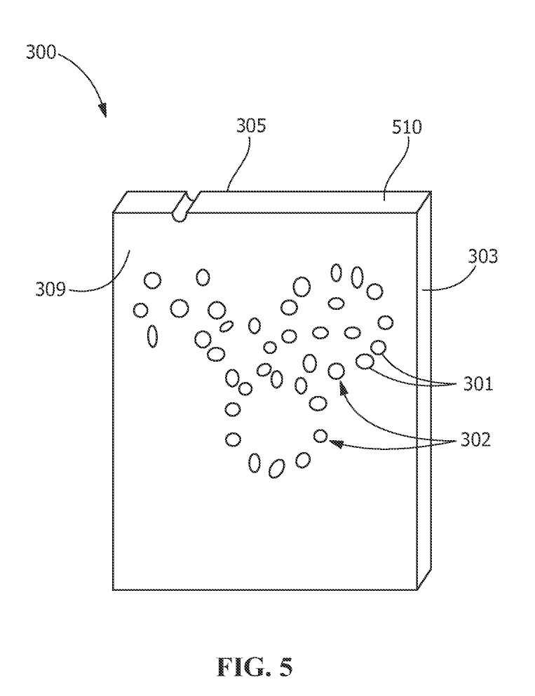

Turning FIG. 2, which shows a cross section of the airfoil portion 103, the component 100 includes a body portion 201 having an outer surface 203 and an inner surface 205. The inner surface 205 defines an inner region 207 of the component 100. In one embodiment, an article 300 is positioned within the inner region 207. The article 300 includes any suitable article for directing fluid flow within the component 100. For example, one suitable article 300 includes an impingement sleeve 310 having a plurality of apertures 301 formed therein (see e.g., FIG. 3). Although primarily described herein with regard to the impingement sleeve 310, as will be understood by those skilled in the art, the article 300 is not so limited and may include any other article having at least one aperture 301 formed therein, such as, but not limited to, an impingement plate 510 (see FIGS. 4-5), multiple impingement plates, multiple impingement sleeves, any other cooling article, or a combination thereof.

As illustrated in FIGS. 2-5, each article 300 includes a base portion 303 having one or more of the apertures 301 extending between an inner article surface 305 and an outer article surface 309 thereof. In one embodiment, such as in the impingement sleeve 310, the base portion 303 forms an enclosure, with the inner article surface 305 defining an inner article region 307, and the outer article surface 309 facing the inner surface 205 of the component 100. In an alternate embodiment, such as in the impingement plate 510, the base portion 303 is positioned to form one or more sections within the inner region 207, with the inner article surface 305 facing the inner region 207 and the outer article surface 309 facing the inner surface 205 of the component 100.

The at least one aperture 301 formed in the article 300 is configured to direct a fluid from the inner region 207 and/or the inner article region 307 towards the inner surface 205 of the component 100. The fluid directed through the aperture(s) 301 contacts the inner surface 205 of the component 100, providing impingement cooling of the body portion 201. In one embodiment, the aperture(s) 301 form an aperture arrangement 302 (see FIGS. 3 and 5). In another embodiment, each of the apertures 301 forms a portion of one of the aperture arrangements 302. In a further embodiment, one of the apertures 301 forms a portion of two or more of the aperture arrangements 302. Additionally or alternatively, the aperture arrangement(s) 302 are positioned between and/or in place of one or more other apertures 301 in a row or column on the outer article surface 309.

The apertures 301 within the aperture arrangement 302 are configured to provide a localized enhanced cooling, or shadowless cooling effect, on the inner surface 205 of the component 100. As used herein, the term “shadowless cooling effect” refers to more than one stream of fluid forming a continuous or substantially continuous section of fluid contact on the inner surface 205 of the component 100, the section of fluid contact being larger than a contact area of any one individual fluid stream from a single aperture 301. The shadowless cooling effect provided by the aperture arrangement(s) 302 provides an increased area of continuous cooling as compared to individual apertures 301 positioned in spaced rows and/or columns. The increased area of continuous cooling decreases or eliminates formation of temperature gradients within the component 100, which decreases or eliminates localized overheating of the component 100 (such as, for example, in the leading edge of a turbine nozzle), increases oxidation resistance of the component 100, increases creep resistance of the component 100, increases a life cycle of the component 100, or a combination thereof. Additionally, the decrease in localized overheating of the component 100 permits the use of increased operating temperatures, which increases an efficiency of the system including the component 100.

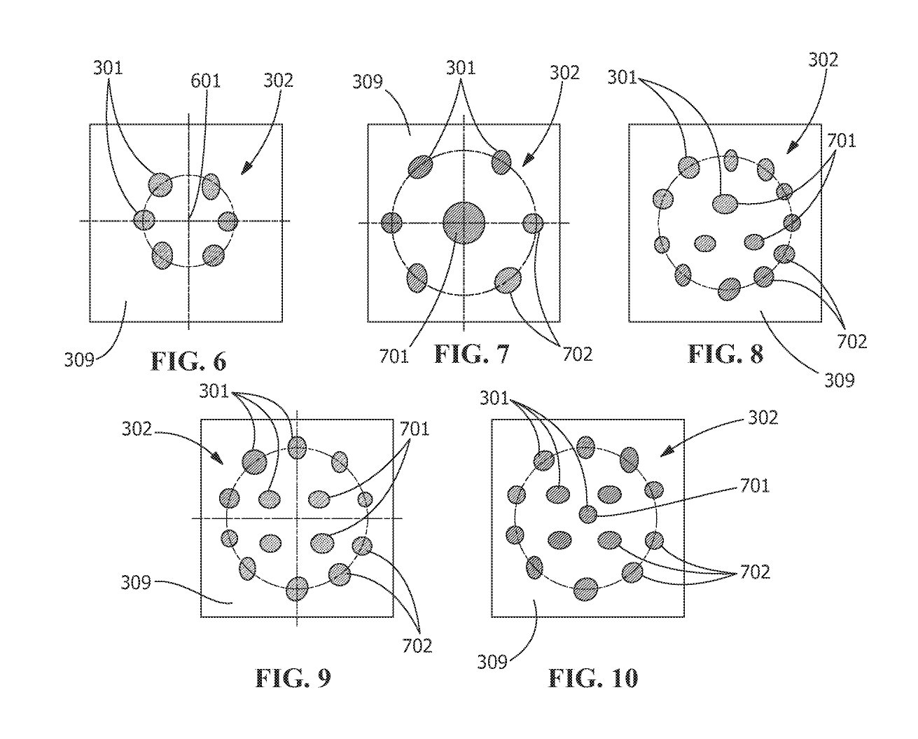

Referring to FIGS. 6-10, each of the aperture arrangements 302 includes any suitable number of apertures 301 in any suitable configuration for providing the shadowless cooling effect. One suitable configuration for providing the shadowless cooling effect includes arranging the apertures 301 to combine the fluid streams exiting the apertures 301 prior to contacting the inner surface 205. In one embodiment, the aperture arrangement 302 includes at least two apertures 301 positioned around a point 601 on the outer article surface 309. The at least two apertures 301 may be positioned symmetrically, asymmetrically, concentrically, circularly, in an oval configuration, triangularly, in a square configuration, and/or in any other geometric configuration around the point 601 on the outer article surface 309. For example, as illustrated in FIG. 6, six of the apertures 301 are positioned circularly around the point 601. In another embodiment, as illustrated in FIGS. 7-10, the aperture arrangement 302 includes at least one central aperture 701 surrounded by at least two surrounding apertures 702. The surrounding apertures 702 may form a single geometric configuration around the at least one central aperture 701, as shown in FIGS. 7-9, or the surrounding apertures 702 may form at least two geometric configurations around the at least one central aperture 701, as shown in FIG. 10. The central aperture(s) 701 and the surrounding apertures 702 are positioned in any suitable arrangement or combination of arrangements, including, but not limited to, symmetrically, asymmetrically, concentrically, circularly, in an oval configuration, triangularly, in a square configuration, and/or in any other geometric configuration.

Each of the apertures 301 includes any suitable geometry for directing the fluid towards the inner surface 205 of the body portion 201. Suitable geometries include, but are not limited to, circular, substantially circular, round, substantially round, oval, non-round, square, triangular, star shaped, polygonal, tear drop, varied, irregular, any other geometrical shape, or a combination thereof. The geometry of the apertures 301 may be uniform, substantially uniform, or varied throughout the article 300, with the geometry of each of the apertures 301 being the same, substantially the same, and/or different from one or more other apertures 301 in the article 300. For example, the central aperture 701 and/or one of the surrounding apertures 702 may have a larger or smaller diameter as compared to another one of the central apertures 701 and/or the surrounding apertures 702. Additionally, the apertures 301 include any suitable orientation and/or spacing for providing the shadowless cooling effect. Suitable spacing between the apertures 301 includes, but is not limited to, even, uniform, varied, gradient, and/or sectioned, with the spacing of each of the apertures 301 being the same, substantially the same, and/or different from one or more other aperture 101. Together, the geometry and orientation of the apertures 301 generate the continuous or substantially continuous section of fluid contact on the inner surface 205 of the component 100, such as, for example, over an area of high heat load.

In one embodiment, forming the component 100, the article 300, and/or the aperture arrangement(s) 302 includes any suitable additive manufacturing method. In another embodiment, the additive method includes making and/or forming net or near-net shape components 100, articles 300, and/or aperture arrangement(s) 302. As used herein, the phrase “near-net” refers to the components 100, articles 300, and/or aperture arrangement(s) 302 being formed with a geometry and size very similar to the final geometry and size of the components 100, articles 300, and/or aperture arrangement(s) 302, requiring little or no machining and processing after the additive method. As used herein, the phrase “net” refers to the components 100, articles 300, and/or aperture arrangement(s) 302 being formed with a geometry and size requiring no machining and processing.

The additive method 500 includes any manufacturing method for forming the component 100, the article 300, and/or the aperture arrangement(s) 302 through sequentially and repeatedly depositing and joining material layers. Suitable manufacturing methods include, but are not limited to, the processes known to those of ordinary skill in the art as Direct Metal Laser Melting (DMLM), Direct Metal Laser Sintering (DMLS), Laser Engineered Net Shaping, Selective Laser Sintering (SLS), Selective Laser Melting (SLM), Electron Beam Melting (EBM), Fused Deposition Modeling (FDM), or a combination thereof.

For example, the DMLM process includes providing a metal alloy powder and depositing the metal alloy powder to form an initial powder layer. The initial powder layer has a preselected thickness and a preselected shape. Next, the DMLM process includes providing a focused energy source, and directing the focused energy source at the initial powder layer to melt the metal alloy powder and transform the initial powder layer to a portion of the component 100, article 300, and/or aperture arrangement(s) 302. Suitable focused energy sources include, but are not limited to, laser device, an electron beam device, or a combination thereof. The DMLM process then includes sequentially depositing additional metal alloy powder over the portion of the component 100, article 300, and/or aperture arrangement(s) 302 to form an additional layer having a second preselected thickness and a second preselected shape corresponding to the preselected shape of the initial layer. After depositing the additional layer of the metal alloy powder, the DMLM process includes melting the additional layer with the focused energy source to increase a combined thickness and form a combined shape of the component 100, article 300, and/or aperture arrangement(s) 302.

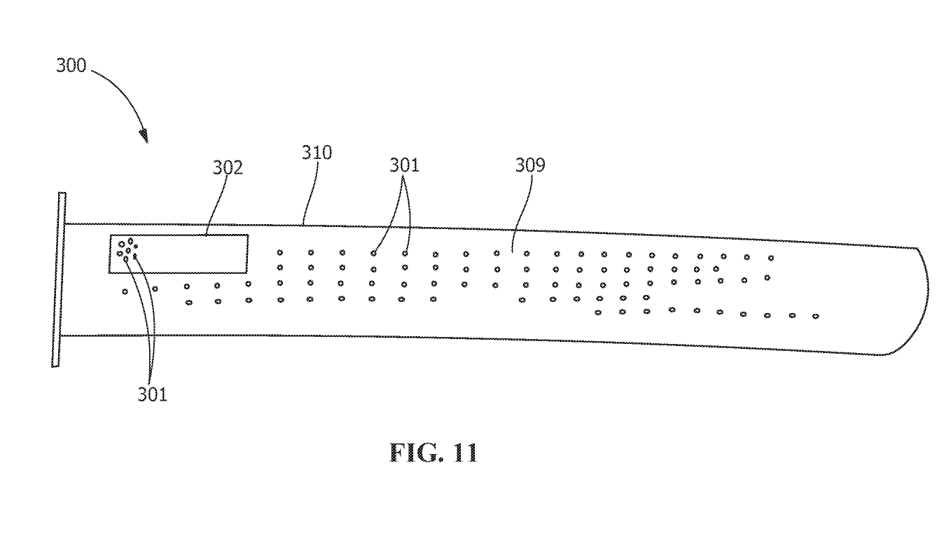

The steps of sequentially depositing the additional layer of the metal alloy powder and melting the additional layer may then be repeated to form the net or near-net shape component 100, article 300, and/or aperture arrangement(s) 302. For example, in one embodiment, the steps may be repeated until the article 300 having the one or more aperture arrangements 302 formed therein is obtained. In another embodiment, the steps may be repeated to form the aperture arrangement(s) 302 directly over a portion of the article 300. Additionally or alternatively, as illustrated in FIG. 11, the aperture arrangement(s) 302 may be formed separately from and/or after the forming of the article 300 then secured to the article 300. Forming the aperture arrangement(s) 302 separate from the article 300 may include either the additive method or a non-additive method such as machining and/or casting.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. An article, comprising:
a base portion arranged and disposed to be positioned within a component; and
an arrangement of apertures formed in the base portion, each of the apertures extending through the base portion;
wherein the arrangement of apertures is arranged and disposed to provide shadowless cooling of an inner surface of the component.

2. The article of claim 1, wherein the arrangement of apertures includes at least two apertures positioned around a section of the base portion.

3. The article of claim 2, wherein the arrangement of apertures is positioned in a substantially circular orientation around the section of the base portion.

4. The article of claim 2, wherein a geometry of at least one of the apertures differs from the geometry of at least one other aperture.

5. The article of claim 1, wherein the arrangement of apertures includes a central aperture and at least two surrounding apertures.

6. The article of claim 5, wherein a diameter of the central aperture is greater than the diameter of each of the surrounding apertures.

7. The article of claim 5, wherein the surrounding apertures are positioned concentrically around the central aperture.

8. The article of claim 5, wherein the surrounding apertures are positioned in a substantially circular orientation around the central aperture.

9. The article of claim 5, wherein the surrounding apertures are positioned in at least two separate configurations, each configuration being concentric with respect to the central aperture.

10. The article of claim 5, wherein a geometry of at least one of the surrounding apertures differs from the geometry of at least one other surrounding aperture.

11. The article of claim 1, wherein the arrangement of apertures includes at least two central apertures and a plurality of surrounding apertures.

12. The article of claim 1, further comprising at least one additional arrangement of apertures, each of the at least one additional arrangements being arranged and disposed to provide shadowless cooling of the structure opposite the outer surface.

13. The article of claim 1, wherein the component comprises a turbine component.

14. A component, comprising:
a body portion having an inner surface and an outer surface, the inner surface defining an inner region; and
an article positioned within the inner region, the article comprising:
a base portion; and
an arrangement of apertures formed in the base portion, each of the apertures extending through the base portion;
wherein the arrangement of apertures is arranged and disposed to provide shadowless cooling of the inner surface of the body portion.

15. The component of claim 14, wherein the component is selected from the group consisting of a hollow component, a hot gas path component, a shroud, a bucket, a vane, a nozzle, and combinations thereof.

16. The component of claim 14, wherein the article is an impingement sleeve.

17. The component of claim 14, further comprising at least one additional arrangement of apertures formed in the base portion, each of the apertures in the additional arrangement extending through the base portion.

18. A method of cooling a component, the method comprising:
directing a fluid into an article within an inner region of the component, the inner region being defined by an inner surface of a body portion of the component;
generating a fluid flow through an arrangement of apertures formed in a base portion of the article, each of the apertures extending through the base portion; and
contacting the inner surface of the body portion with the fluid flow, the contacting of the inner surface providing shadowless cooling of the inner surface.

19. The method of claim 18, further comprising:
generating additional fluid flow through at least one additional arrangement of apertures formed in the base portion of the article; and
contacting the inner surface of the body portion with the additional fluid flow, the contacting of the inner surface providing shadowless cooling of the inner surface.

20. The method of claim 18, wherein the component is selected from the group consisting of a hollow component, a hot gas path component, a shroud, a nozzle, a vane, a bucket, and combinations thereof.
